(19) United States
(12) Patent Application Publication
(10) Pub. No.: US 2017/0167177 A1
(43) Pub. Date: Jun. 15, 2017

(54) WINDOW REGULATOR

(71) Applicant: Johnan Manufacturing Inc., Nagano (JP)

(72) Inventors: Hiroki SHIMIZU, Nagano (JP); Manabu SHIMOMURA, Nagano (JP); Seiichi MIYAMOTO, Nagano (JP)

(21) Appl. No.: 15/115,550

(22) PCT Filed: Feb. 5, 2015
(86) PCT No.: PCT/JP2015/053258

§ 371 Date: Jul. 29, 2016

(30) Foreign Application Priority Data
Feb. 6, 2014 (JP) 2014-021494

(51) Int. Cl. E05F 15/689; B60J 5/04; B60J 1/17; E05F 15/695; E05F 15/697

(52) U.S. Cl. CPC E05F 15/689; E05F 15/695; E05F 15/697; B60J 1/17; B60J 5/0419; B60J 5/0402

(57) ABSTRACT

A window regulator (1) provided in a vehicle door (9) to raise and lower a windowpane (90) in the door (9) includes a guide rail (20) arranged along the travel direction of the windowpane (90), a wire (3) tensely fitted along the longitudinal direction of the guide rail (20), and a traveling body (4) that is guided by the guide rail (20) and travels together with the windowpane (90). The traveling body (4) includes a drum (40) with a part of the wire (3) wound thereon, a motor (5) generating a drive force that rotates and drives the drum (40), and a housing (6) that holds the drum (40) and the motor (5). Both end portions of the wire (3) are held by first and second wire support members (21) and (22) that are provided at an upper end portion and a lower end portion of the guide rail (20).

### TECHNICAL FIELD

The present invention relates to a window regulator that raises and lowers a windowpane in a vehicle door.

### BACKGROUND ART

Conventional, a window regulator is used in vehicle door so as to raise and lower windowpane by a drive force of a motor (see, e.g., PTL 1).

The window regulator described in PTL 1 is provided with a guide rail fixed to a door inner panel along the travel direction of a window glass which is an object to be opened and closed, a wire tightly stretched along the longitudinal direction of the guide rail, a carrier traveling with the window glass while being guided by the guide rail, and a drive unit which drives the carrier through the wire.

The drive unit has a drum with a wire wound around the outer peripheral surface thereof, and a motor to rotate the drum. In addition, a pulley for changing the direction of the wire is arranged at an upper end portion of the guide rail, and a semicircular guide also for changing the direction of the wire is arranged at a lower end portion of the guide rail. The wire is fixed, at both ends, to the carrier, changes the direction at the pulley and the semicircular guide, and is wound around the drum between the pulley and the semicircular guide.

The both ends of the wire are fixed to the carrier via looseness-preventing springs. The wire is thereby tensioned. When the wire from the drum to the carrier via the pulley is defined as a raising wire and the wire from the drum to the carrier via the semicircular guide as a lowering wire, the motor rotates forward during ascent of the carrier to cause the drive unit to take up the raising wire and to let out the lowing wire. On the other hand, the motor rotates reversely during descent of the carrier to cause the drive unit to take up the lowing wire and to let out the raising wire. The window glass thereby moves vertically together with the carrier.

### CITATION LIST

### Patent Literature

### [PTL 1]

### JP-A-2010-285793

### SUMMARY OF INVENTION

### Technical Problem

In the window regulator described in PTL 1, since the wire practically runs up and then down between the pulley and the semicircular guide, the wire needs to have enough length to provide a portion to be wound around the drum as well as a portion to run up and down between the pulley and the semicircular guide. In addition, changing the direction of the wire at the pulley and the semicircular guide may cause a problem in durability of the wire. Furthermore, wire routing work during manufacturing of the window regulator is complicated.

It is an object of an embodiment of the invention to provide a window regulator that allows shortening of the wire, enhanced durability of the wire and easiness in manufacture.

### Solution to Problem

According to one embodiment of the invention, provided is a window regulator which is provided in a door of a vehicle to raise and lower a windowpane in the door and comprises:
a guide rail arranged along a travel direction of the windowpane;
a wire tensely fitted along a longitudinal direction of the guide rail; and
a traveling body that is guided by the guide rail and travels together with the windowpane,
wherein the traveling body comprises a drum with a part of the wire wound thereon, a motor that generates a drive force to rotate and drive the drum, and a housing that holds the drum and the motor, and
wherein both end portions of the wire are held by a pair of wire holding portions that are provided at an upper end portion and a lower end portion of the guide rail.

### Advantageous Effects of Invention

According to an embodiment of the invention, a window regulator can be provided that allows shortening of the wire, enhanced durability of the wire and easiness in manufacture.

### BRIEF DESCRIPTION OF DRAWINGS

FIG. 1 is an illustration diagram showing a window regulator in an embodiment of the present invention and a vehicle door mounting the window regulator.

FIG. 2 is a cross sectional view taken along a line A-A in FIG. 1 and showing the inside of the door mounting the window regulator.

FIG. 3 is an illustration diagram showing the entire window regulator.

FIG. 4 is an exploded perspective view showing the window regulator.

FIG. 5 is a cross sectional view taken along a line B-B in FIG. 3.

FIG. 6A is a side view showing a second wire support member and the periphery thereof at the lower end portion of a guide rail.

FIG. 6B is a front view showing the second wire support member and the periphery thereof at the lower end portion of the guide rail.

FIG. 6C is a cross sectional view taken along a line C-C in FIG. 6A.

FIG. 6D is a cross sectional view taken along a line D-D in FIG. 6B.

FIG. 6E is a cross sectional view taken along a line E-E in FIG. 6B.

FIG. 6F is a cross sectional view taken along a line F-F in FIG. 6B.

FIG. 6G is a cross sectional view showing a piston member.

FIG. 7A is a top view showing a first wire support member.

FIG. 7B is a left side view showing the first wire support member.

FIG. 7C is a front view showing the first wire support member.

FIG. 7D is a right side view showing the first wire support member.

FIG. 7E is a rear view showing the first wire support member.

FIG. 7F is a bottom view showing the first wire support member.

FIG. 7G is a perspective view showing the first wire support member.

### DESCRIPTION OF EMBODIMENTS

### Embodiment

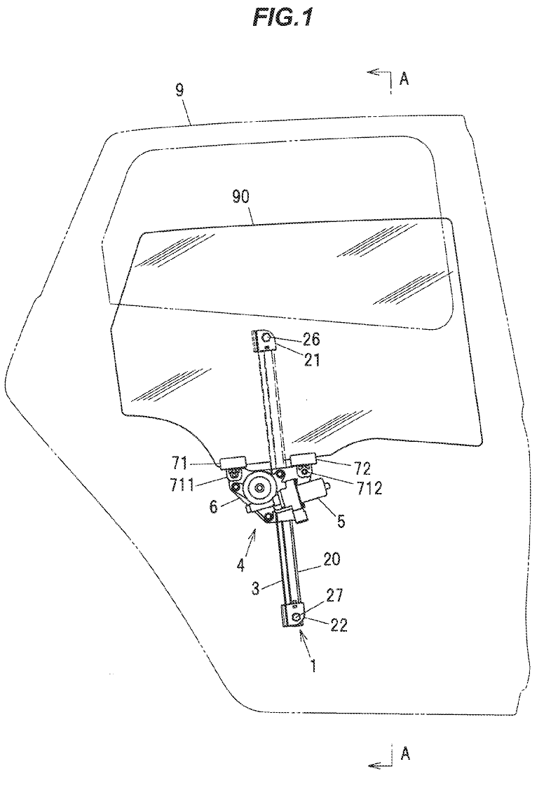

An embodiment of the invention will be described in reference to FIGS. 1 to 7G.

FIG. 1 is an illustration diagram showing a window regulator in the present embodiment and a vehicle door mounting the window regulator. FIG. 1 shows a right rear door when viewing from the outside of the vehicle. In addition, in FIG. 1, the outline of the door and the window frame are indicated by phantom lines (dash-dot-dot lines), and a portion of the window regulator arranged on the inner side (the vehicle interior side) of the windowpane is indicated by a dashed line.

A window regulator 1 is provided in a door 9 of a vehicle to raise and lower a windowpane 90 of the door 9. The windowpane 90 moves vertically while being guided by a window guide (not shown). Although FIG. 1 shows an example in which the window regulator 1 is used in the right rear door of the vehicle, it is also possible to provide the window regulator 1 in another door of the vehicle.

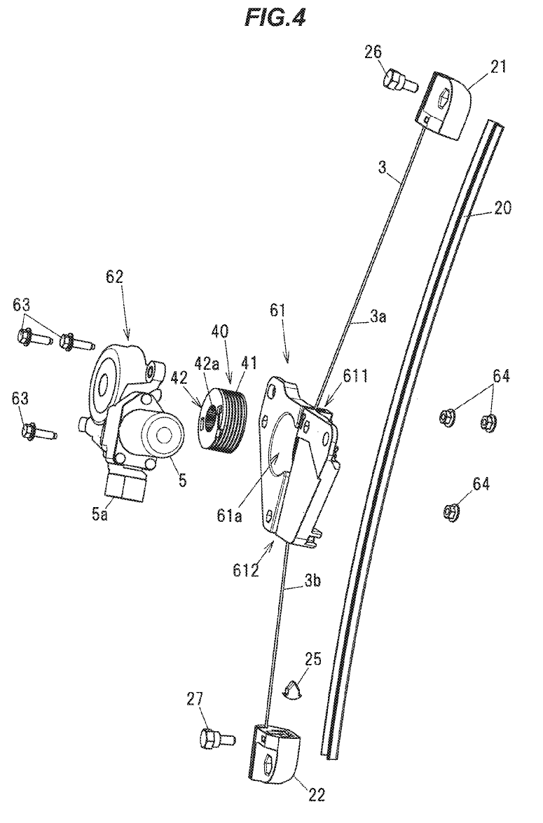

The window regulator 1 is provided with a guide rail 20 arranged along the travel direction of the windowpane 90, a wire 3 tensely fitted along the longitudinal direction of the guide rail 20, and a traveling body 4 which is guided along the guide rail 20 and travels together with the windowpane 90. The traveling body 4 has a drum 40 (shown in FIG. 4 described later) with a portion of the wire 3 wound thereon, a motor 5 generating a drive force to rotate and drive the drum 40, a housing 6 holding the drum 40 and the motor 5, and joining members 71 and 72 which join the windowpane 90 to the housing 6. The detailed configuration of the traveling body 4 will be described later.

A first wire support member 21 is arranged at an upper end portion of the guide rail 20, and a second wire support member 22 is arranged at a lower end portion of the guide rail 20. The first wire support member 21 and the second wire support member 22 serves as a pair of wire holding portions for supporting both end portions of the wire 3.

The motor 5 is arranged at a position not overlapping the joining members 71 and 72 when viewing the window regulator 1 in the vehicle width direction. In more detail, the motor 5 is arranged at a downwardly offset position with respect to the joining member 72 which is fixed to the housing 6 at an edge on the forward side of the vehicle. This reduces the thickness of the traveling body 4 in the vehicle width direction while avoiding contact of the motor 5 with the joining members 71 and 72.

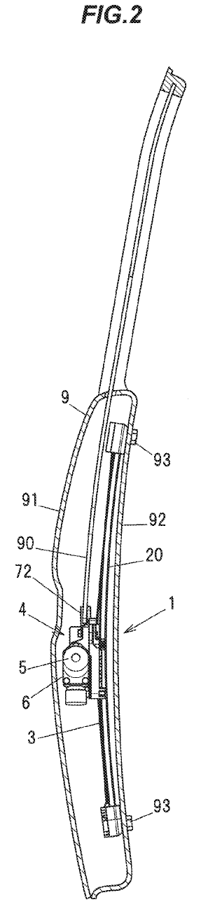

FIG. 2 is a cross sectional view taken along the line A-A in FIG. 1 and showing the inside of the door 9 mounting the window regulator 1.

The window regulator 1 is arranged between an outer wall 91 and an inner wall 92 of the door 9. A surface of the inner wall 92 on the vehicle interior side (on the opposite side to the outer wall 91) is covered with a lining (not shown) formed of, e.g., a resin. The outer wall 91 is curved such that the middle portion in a height direction bulges outward in the vehicle width direction. The windowpane 90 is also curved such that the middle portion in a height direction bulges outward in the vehicle width direction, in the same manner as the outer wall 91. The guide rail 20 is curved in an are shape along the windowpane 90.

The first wire support member 21 and the second wire support member 22 of the window regulator 1 are fixed to the inner wall 92. The first wire support member 21 is attached to the inner wall 92 by a bolt 26 (shown in FIG. 1) which is inserted through the first wire support member 21. A tip portion of the bolt 26 penetrates the inner wall 92 and is threaded into a nut 93 which is arranged on the vehicle interior side of the inner wall 92. Meanwhile, the second wire support member 22 is attached to the inner wall 92 by a bolt 27 (shown in FIG. 1) which is inserted through the second wire support member 22. A tip portion of the bolt 27 penetrates the inner wall 92 and is threaded into another nut 93 which is arranged on the vehicle interior side of the inner wall 92.

The motor 5 is arranged inside the door 9 further on the outside in the vehicle width direction than the guide rail 20. A space with a width which does not disturb the movement of the traveling body 4 is formed between the guide rail 20 and the outer wall 91.

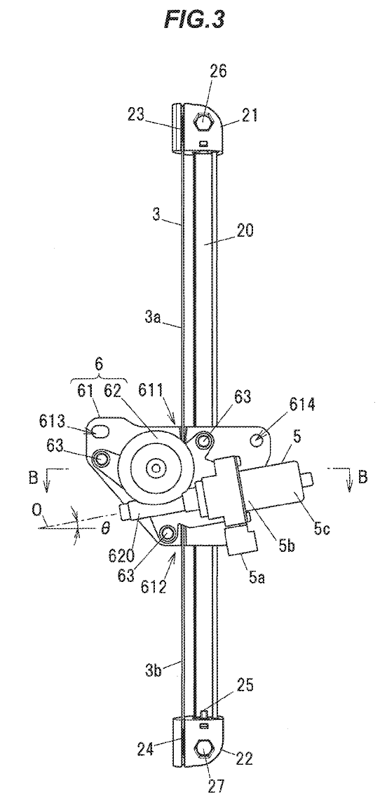

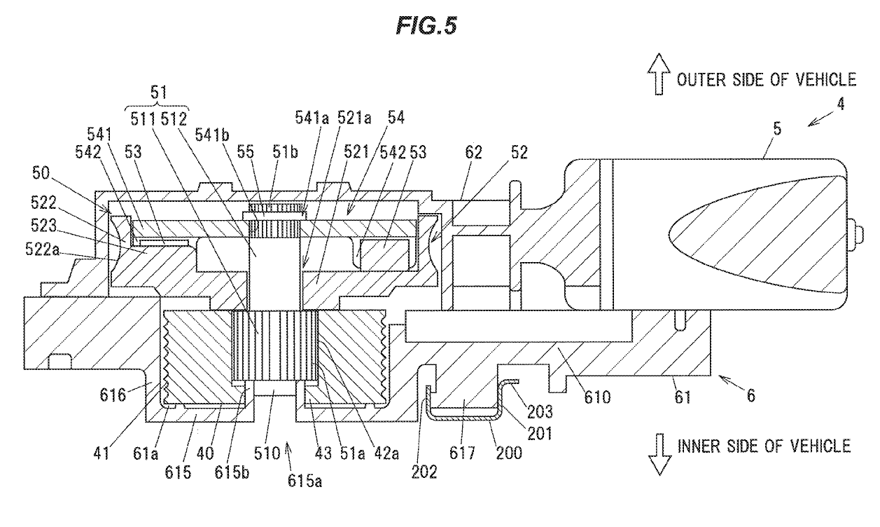

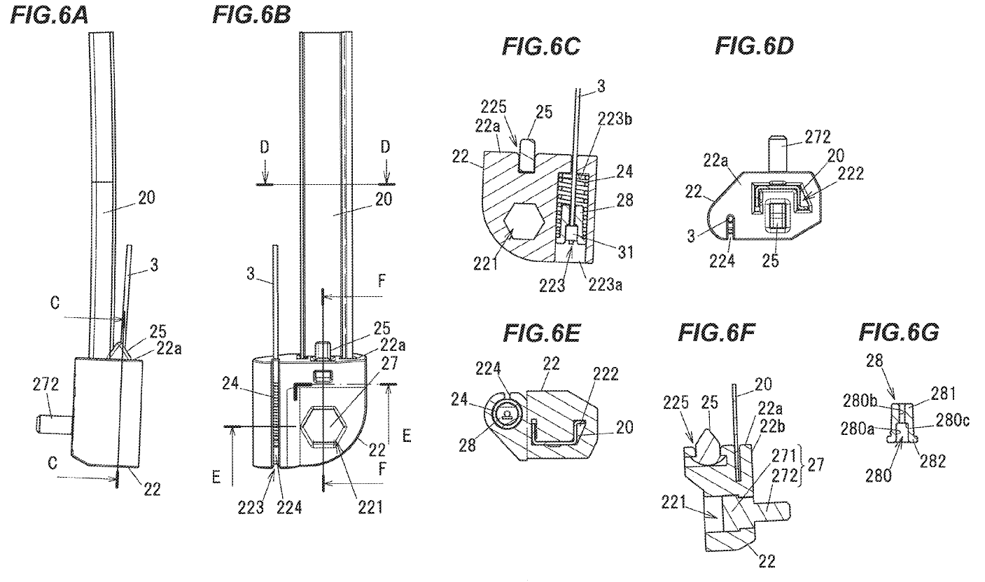

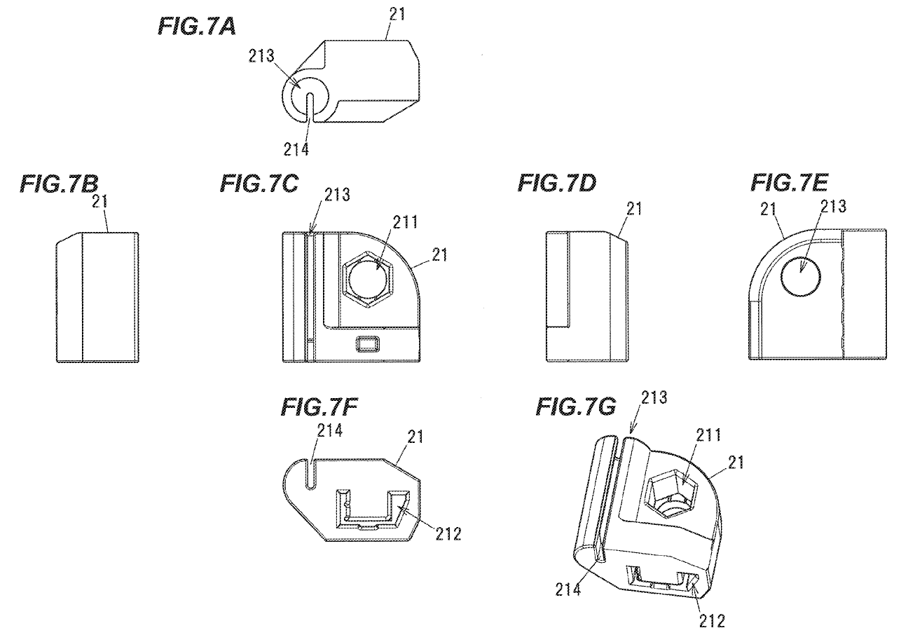

Next, the configuration of each component of the window regulator 1 will be described in detail in reference to FIGS. 3 to 7G. FIG. 3 is an illustration diagram showing the entire window regulator 1. FIG. 4 is an exploded perspective view showing the window regulator 1. FIG. 5 is a cross sectional view taken along the line B-B in FIG. 3. FIGS. 6A to 6G show the second wire support member 22 and the periphery thereof at the lower end portion of the guide rail 20, wherein FIG. 6A is a side view, FIG. 6B is a front view, FIG. 6C is a cross sectional view taken along the line C-C in FIG. 6A, FIG. 6D is a cross sectional view taken along the line D-D in FIG. 6B, FIG. 6E is a cross sectional view taken along the line E-E in FIG. 6B, FIG. 6F is a cross sectional view taken along the line F-F in FIG. 6B, and FIG. 6G is a cross sectional view showing a piston member. FIGS. 7A to 7G show the first wire support member 21 and are respectively a top view, a left side view, a front view, a right side view, a rear view, a bottom view and a perspective view. In the following description, “up/upper/above” and “down/lower/below” mean “an upper side” and “a lower side” of the window regulator 1 when mounted on the door 9.

As shown in FIGS. 3 and 4, the housing 6 is composed of a drum housing 61 for housing the drum 40 and a gear housing 62 for housing a worm gear mechanism 50 (shown in FIG. 5 and described later). The drum housing 61 and the gear housing 62 are fastened to each other by plural bolts 63 and nuts 64. Both the drum housing 61 and the gear housing 62 are formed of resins. In more detail, the drum housing 61 is formed of, e.g., polyacetal (POM) and the gear housing 62 is formed of, e.g., polybutylene terephthalate (PBT).

As shown in FIG. 4, a housing space 61a for housing the drum 40 is formed on the drum housing 61. In addition, a first guide groove 611 and a second guide groove 612 for guiding the wire 3 to the housing space 61a are formed on the drum housing 61. The first guide groove 611 is formed above the housing space 61a and opens toward the first wire support member 21. The second guide groove 612 is formed below the housing space 61a and opens toward the second wire support member 22. The first guide groove 611 and the second guide groove 612 are formed at position offset from the center of the housing space 61a toward the guide rail 20.

The drum housing 61 also has through-holes 613 and 614 formed at both ends in a fore-and-aft direction of the vehicle. The joining members 71 and 72 (shown in FIG. 1) are fixed to the drum housing 61 by bolts 711 and 712 (shown in FIG. 1) which are respectively inserted into the through-holes 613 and 614.

The drum 40 is formed in a cylindrical shape and has a helical groove 41 on the outer surface thereof. In addition, inner splines 42a extending in an axial direction of the drum 40 are formed on an inner peripheral surface of a center hole 42 of the drum 40.

The wire 3 is tensioned by springs 23 and 24 (shown in FIG. 3) as elastic bodies which are held by the first wire support member 21 and the second wire support member 22. Thus, the wire 3 is tightly stretched without looseness between the first wire support member 21 and the second wire support member 22. The detailed configuration of the first wire support member 21 and the second wire support member 22 will be described later.

The routing path of the wire 3, which starts from the end portion on the first wire support member 21 side and terminates at the end portion on the second wire support member 22 side, is as follows: the wire 3 extending out of the first wire support member 21 runs downward along the guide rail 20 and is guided into the housing space 61a via the first guide groove 611 of the drum housing 61. The wire 3 guided into the housing space 61a is wound around the drum 40 several times so as to be fitted in the groove 41 on the outer surface of the drum 40, and extends out to the outside of the drum housing 61 via the second guide groove 612. The wire 3 extending out from the second guide groove 612 runs downward along the guide rail 20 and is supported by the second wire support member 22.

When the wire 3 between the first wire support member 21 and the drum housing 61 is defined as an upper wire 3a and the wire 3 between the second wire support member 22 and the drum housing 61 as a lower wire 3b, rotation of the drum 40 causes a change in lengths of the upper wire 3a and the lower wire 3b. In other words, when the rotation direction of the drum 40 during ascent of the traveling body 4 is defined as a forward direction and the rotation direction of the drum 40 during descent of the traveling body 4 as a reverse direction, the rotation of the drum 40 in the forward direction causes the length of the upper wire 3a to be shortened and the length of the lower wire 3b to be lengthened. Inversely, the rotation of the drum 40 in the reverse direction causes the length of the upper wire 3a to be lengthened and the length of the lower wire 3b to be shortened. The traveling body 4 moves vertically along the guide rail 20 according to the change in the lengths of the upper wire 3a and the lower wire 3b.

The motor 5 is a DC motor which receives an electric current through a connector portion 5a and generates a rotational drive force. A worm (not shown) housed in a cylindrical portion 620 of the gear housing 62 is coupled to a rotor of the motor 5 so as to rotate integrally. As shown in FIG. 3, a rotation axis O of the rotor of the motor 5 and the worm is inclined at an angle θ with respect to a straight line orthogonal to the longitudinal direction of the guide rail 20. With the inclination of the rotation axis O, the motor 5 is arranged such that a front end portion 5c on the opposite side to the gear housing 62 is located higher than a base end portion 5b fixed to the gear housing 62.

The rotation of the motor 5 is decelerated by the worm gear mechanism 50 (described later) housed in the gear housing 62 and is transmitted to the drum 40 via the output shaft 51 (shown in FIG. 5) of the worm gear mechanism 50. As shown in FIG. 5, an end portion of an output shaft 51 protrudes from the gear housing 62. Outer splines 51a to be engaged with the inner splines 42a (shown in FIG. 4) formed on the inner peripheral surface of the center hole 42 of the drum 40 are formed on the outer peripheral surface of the end portion of the output shaft 51.

The output shaft 51 is coupled to the drum 40 by spline engagement between the outer splines 51a and the inner splines 42a of the drum 40 so as not to be relatively rotatable. In addition, a supported portion 510 is formed at the center of the output shaft 51 protruding from the gear housing 62 and is supported by the drum housing 61. The supported portion 510 has a smaller diameter than the portion having the outer splines 51a and protrudes toward the drum housing 61.

As shown in FIG. 5, the worm gear mechanism 50 has the output shaft 51, a worm wheel 52 which meshes with the worm (not shown) coupled to the rotor of the motor 5, plural dumpers 53 formed of an elastic body such as rubber, and a hub 54 which receives a rotational force from the worm wheel 52 via the plural dumpers 53 and rotates integrally with the output shaft 51. In FIG. 5, the outer side of the vehicle (the outer wall 91 side of the door 9) is shown on the upper side and the inner side of the vehicle (the inner wall 92 side of the door 9) is shown on the lower side.

The output shaft 51 integrally has a large diameter portion 511 protruding from the gear housing 62 and a small diameter portion 512 having a smaller diameter than the large diameter portion 511. The outer splines 51a to be spline-engaged with the inner splines 42a of the drum 40 are formed on the outer peripheral surface of the large diameter portion 511. On the small diameter portion 512, outer splines 51b to be spline-engaged with the hub 54 are formed at an end on the opposite side to the large diameter portion 511.

The worm wheel 52 integrally has a circular plate-shaped bottom portion 521 having an insertion hole 521a formed in the center for insertion of the output shaft 51, an outer circumferential wall portion 522 formed along the outer rim of the bottom portion 521 so as to protrude in the axial direction, and plural inner wall portions 523 protruding inward from an inner surface of the outer circumferential wall portion 522. Only one of the plural inner wall portions 523 is shown in FIG. 5.

Worm teeth 522a are formed on the outer peripheral surface of the outer circumferential wall portion 522. An inner diameter of the insertion hole 521a of the bottom portion 521 is larger than an outer diameter of the small diameter portion 512 of the output shaft 51, so a small gap is formed between the inner peripheral surface of the insertion hole 521a and the outer peripheral surface of the small diameter portion 512 of the output shaft 51.

The hub 54 integrally has a disk-shaped main body 541 having an insertion hole 541a formed in the center for insertion of the small diameter portion 512 of the output shaft 51, and plural protrusions 542 protruding from the main body 541 toward the bottom portion 521 of the worm wheel 52. Inner splines 541b to be spline-engaged with the outer splines 51b of the small diameter portion 512 of the output shaft 51 are formed on the inner peripheral surface of the insertion hole 541a. The hub 54 is restricted from relatively moving with respect to the output shaft 51 by a snap ring 55 which is fitted to the small diameter portion 512 of the output shaft 51.

The dumpers 53 are sandwiched between the inner wall portions 523 of the worm wheel 52 and the protrusions 542 of the hub 54. The dumpers 53 have a function of absorbing torque pulsation of the motor 5 to smoothly rotate the output shaft 51. The worm wheel 52 and the hub 54 are relatively rotatable in an elastically deformable and compressible range of the dumpers 53. The worm gear mechanism 50 having such a configuration decelerates the rotation of the rotor of the motor 5 and transmits the rotation to the output shaft 51 while reducing the torque pulsation.

The drum housing 61 has a through-hole 615a formed in the center of a bottom portion 615 which defines the housing space 61a. Also, a cylindrical protruding portion 615b is formed around the through-hole 615a of the bottom portion 615. The supported portion 510 of the output shaft 51 is inserted into the protruding portion 615b. The supported portion 510 is thereby supported by the drum housing 61, resulting in that the output shaft 51 is rotatably supported.

An inner flange portion 43 is formed to protrude inward from the inner peripheral surface of the center hole 42 of the drum 40 at an edge on a side facing the bottom portion 615 of the drum housing 61. The front end surface of the inner flange portion 43 faces the outer peripheral surface of the protruding portion 615b with a small gap therebetween. Thus, the drum 40 is rotatably supported inside the housing space 61a. The outer peripheral surface of the drum 40 faces a circumferential wall portion 616 which, together with the bottom portion 615, defines the housing space 61a.

In addition, a protruding strip 617 extending in the vertical direction is formed on the drum housing 61. The protruding strip 617 protrudes from a main body 610 of the drum housing 61 toward the inner wall 92 of the door 9 (toward the vehicle interior). The protruding strip 617 slides and moves on the guide rail 20 and the drum housing 61 is thereby guided along the guide rail 20.

The guide rail 20 is formed by bending, e.g., a metal plate such as zinc steel plate. The guide rail 20 integrally has a flat bar portion 200 extending in the longitudinal direction thereof (the vertical direction), a first side wall portion 201 and a second side wall portion 202 which are provided upright on the flat bar portion 200 to protrude from both edges in a width direction toward the main body 610 of the drum housing 61, and a flange portion 203 protruding from a top end of the first side wall portion 201 toward the opposite side to the flat bar portion 200. The width direction here is a lateral direction orthogonal to the longitudinal direction of the guide rail 20 and corresponds to the fore-and-aft direction of the vehicle.

The protruding strip 617 of the drum housing 61 is arranged between the first side wall portion 201 and the second side wall portion 202. That is, since the protruding strip 617 is interposed between the first side wall portion 201 and the second side wall portion 202, the drum housing 61 is restricted from tilting relative to the guide rail 20.

Next, the configuration of the second wire support member 22 arranged at the lower end portion of the guide rail 20 will be described in reference to FIGS. 6A to 6G.

The second wire support member 22 has a hole 221 for housing the bolt 27 which is a fixing member for fixing the guide rail 20 to the door 9, a fitting recess 222 for fitting the lower end portion of the guide rail 20, a housing hole 223 for housing the spring 24, a slit 224 extending along the housing hole 223, and a fixing portion 225 for fixing a stopper 25 formed of an elastic member such as rubber.

The second wire support member 22 is fixed to the guide rail 20 by fitting the lower end portion of the guide rail 20 to the fitting recess 222 and is prevented from slipping out by tension of the wire 3 imparted by the spring 24. In the present embodiment, the spring 24 is constructed from a cylindrical coil spring formed by helically winding a wire-shaped highly-elastic metal such as spring steel. The elastic body for imparting tension to the wire 3 is not limited to the coil spring and it is possible to use various springs such as plate spring. Alternatively, rubber or elastomer may be used as the elastic body.

The housing hole 223 for housing the spring 24 has an opening on the vehicle lower side. The spring 24 is inserted into the housing hole 223 through this opening 223a. Together with the spring 24, a piston member 28 is also housed in the housing hole 223. As shown in FIG. 6G, the piston member 28 has a cylindrical shaft portion 281 to be arranged inside the spring 24, a protruding portion 282 protruding outward from the shaft portion 281, and a through-hole 280 formed in the core of the shaft portion. The through-hole 280 is composed of a large diameter portion 280a formed on the protruding portion 282 side and a small diameter portion 280b having a smaller diameter than the large diameter portion 280a.

A wire end stop 31 is fixed to an end portion of the wire 3, as shown in FIG. 6C. The wire end stop 31 is formed of, e.g., a metal and is crimped to the end portion of the wire 3. The wire end stop 31 is housed in the large diameter portion 280a of the through-hole 280 of the piston member 28 and is in contact with a step surface 280c between the large diameter portion 280a and the small diameter portion 280b. The wire 3 extends through the small diameter portion 280b.

The outer diameter of the protruding portion 282 of the piston member 28 is larger than the outer diameter of the spring 24, so the protruding portion 282 is in contact with one end of the spring 24. Another end of the spring 24 is in contact with a bottom surface 223b of the housing hole 223. In other words, the spring 24 is sandwiched between the protruding portion 282 of the piston member 28 and the bottom surface 223b of the housing hole 223 and is arranged in an axially compressed state. Thus, the piston member 28 is pressed toward the opening 223a of the housing hole 223 by the spring 24.

The piston member 28 is pressed by the spring 24 and the wire 3 is thereby tensioned. This prevents looseness of the lower wire 3b (shown in FIG. 3).

The stopper 25 is provided on the second wire support member 22 by being fixed to the fixing portion 225 of the second wire support member 22. The stopper 25 protrudes upwards from an upper end surface 22a of the second wire support member 22. In the present embodiment, the fixing portion 225 is a recessed portion formed to extend downward from the upper end surface 22a of the second wire support member 22.

The stopper 25 comes into contact with the drum housing 61 of the housing 6 when the traveling body 4 moves down toward the second wire support member 22, thereby restricting the traveling body 4 from moving further downward. Since the stopper 25 has elasticity, contact of the housing 6 with the stopper 25 reduces an impact applied when the traveling body 4 reaches the end point of the stroke.

The second wire support member 22 is fixed to the inner wall 92 (shown in FIG. 2) of the door 9 by the bolt 27 inserted into the hole 221. In more detail, the bolt 27 is inserted into the hole 221 from the outer wall 91 side toward the inner wall 92 of the door 9 and a polygonal bolt head 271 is housed in the hole 221. A shaft 272 of the bolt 27 penetrates the inner wall 92 and is threaded into a nut 93 which, together with an inner surface 22b of the second wire support member 22, sandwiches the inner wall 92 of an attachment member 922.

The first wire support member 21 is configured in the same manner as the second wire support member 22, except that the stopper 25 is not provided. As shown in FIGS. 7A to 7G, the first wire support member 21 has a hole 211 for housing the bolt 26 which is a fixing member for fixing the guide rail 20 to the door 9, a fitting recess 212 for fitting the upper end portion of the guide rail 20, a housing hole 213 for housing the spring 23, and a slit 214 extending along the housing hole 213.

The spring 23 (shown in FIG. 3) constructed from a coil spring is housed in the housing hole 213. Also, another piston member 28 having the same configuration as described in reference to FIG. 6G is housed in the housing hole 213. Furthermore, another wire end stop 31 having the same configuration as described in reference to FIG. 6C is fixed to another end portion of the wire housed in the housing hole 213. Due to this configuration, the spring 23 is arranged in the housing hole 213 of the first wire support member 21 in the axially compressed state and the wire 3 is thereby tensioned. This prevents looseness of the upper wire 3a (shown in FIG. 3).

When the traveling body 4 moves upward to the end point of the stroke, the windowpane 90 butts against a glass run (not shown) provided on a window frame and is restricted from moving. Therefore, it is not necessary to provide the stopper 25 on the first wire support member 21.

Next, a method of manufacturing the window regulator 1 (assembly procedure) will be described. An example procedure for assembling the first wire support member 21, the second wire support member 22, the springs 23, 24 and the piston members 28 with the guide rail 20 will be described here.

The first wire support member 21, the second wire support member 22, the springs 23, 24 and the piston members 28 are assembled with the guide rail 20 through the following first to third steps.

### (First Step)

The first step is a step of assembling the springs 23, 24, a pair of piston members 28 and wire end stops 31 with the wire 3. In the first step, the wire 3 is inserted to pass through the springs 23 and 24 and the pair of piston members 28, and the wire end stops 31 are fixed to the both end portions of the wire 3 by crimping so that the springs 23 and 24 and the pair of piston members 28 do not slip off from the wire 3.

### (Second Step)

The second step is a step of assembling the first wire support member 21, the spring 23 and the piston member 28 with the upper end portion of the guide rail 20. In the second step, the upper end portion of the guide rail 20 is fitted into the fitting recess 212 of the first wire support member 21, and the spring 23 and the piston member 28 are inserted into the housing hole 213 of the first wire support member 21. In this regard, the work to fit the upper end portion of the guide rail 20 into the fitting recess 212 of the first wire support member 21 may be carried out first, or the work to insert the spring 23 and the piston member 28 into the housing hole 213 of the first wire support member 21 may be carried out first.

### (Third Step)

The third step is a step of assembling the second wire support member 22, the spring 24 and the piston member 28 with the lower end portion of the guide rail 20. In the third step, the spring 24 and the piston member 28 are inserted into the housing hole 223 of the second wire support member 22, and the lower end portion of the guide rail 20 is subsequently fitted into the fitting recess 222 of the second wire support member 22 while compressing the springs 23 and 24 by pressing the second wire support member 22 along the guide rail 20 in a direction separating from the first wire support member 21. Alternatively, after fitting the lower end portion of the guide rail 20 into the fitting recess 222 of the second wire support member 22, the spring 24 and the piston member 28 may be inserted into the housing hole 223 of the second wire support member 22 while compressing the springs 23 and 24. In this case, the wire 3 is inserted into the housing hole 223 through the slit 214 of the first wire support member 21.

Through the above steps, the wire 3 is tensioned by the springs 23 and 24 and is tensely fitted along the longitudinal direction of the guide rail. It is also possible to assemble the window regulator 1 by a procedure other than the above-described assembly procedure. For example, although the second wire support member 22, etc., is assembled with the lower end portion of the guide rail 20 after assembling the first wire support member 21, etc., with the upper end portion of the guide rail 20 in the above-described assembly procedure, it is not limited thereto. The first wire support member 21, etc., may be assembled with the upper end portion of the guide rail 20 after assembling the second wire support member 22, etc., with the lower end portion of the guide rail 20.

### Functions and Effects of the Embodiment

The following functions and effects are obtained in the embodiment.

(1) Since both end portions of the wire 3 are supported by the first wire support member 21 and the second wire support member 22 which are provided on the upper end portion and the lower end portion of the guide rail 2, the wire 3 does not run up and down between both end portions of the guide rail 2. Since this allows the length of the wire 3 to be reduced and also the wire 3 does not change the direction at the upper end portion and the lower end portion of the guide rail 2, durability of the wire 3 is improved. In addition, the wire 3 is easily arranged during production of the window regulator 1.

(2) The wire 3 is tensioned by the springs 23 and 24 which are held by the first wire support member 21 and the second wire support member 22. Thus, it is possible to prevent looseness of the wire 3 by a simple structure.

(3) The holes 211 and 221 for housing the bolts 26 and 27 for fixing the guide rail 2 to the door 9 are formed on the first wire support member 21 and the second wire support member 22. In other words, the first wire support member 21 and the second wire support member 22 have a function of supporting the wire 3 as well as a function for fixing the guide rail 2 to the door 9. Thus, it is possible to simplify the attachment structure to attach the window regulator 1 to the door 9.

(4) Since the stopper 25 formed of an elastic member is provided on the second wire support member 22, an impact applied when the traveling body 4 reaches the end point of the stroke is reduced. In other words, the second wire support member 22 also has a function of reducing an impact when the traveling body 4 moves.

Although the invention has been described based on the embodiment, the invention according to claims is not to be limited to the above-mentioned embodiment. Further, please note that all combinations of the features described in the embodiment are not necessary to solve the problem of the invention.

In addition, the invention can be appropriately modified and implemented without departing from the gist thereof. For example, although the wire 3 in the embodiment is tensioned by being held by the first wire support member 21 and the second wire support member 22 in the state that the springs 23 and 24 are compressed in the axial direction, it is not limited thereto. The wire 3 may be held by the first wire support member 21 and the second wire support member 22 in a state that the springs 23 and 24 are stretched from natural length so that tension is applied by a restoring force.

### INDUSTRIAL APPLICABILITY

The invention is applicable to a window regulator provided inside a vehicle door to raise and lower a windowpane by a drive force of a motor.

### REFERENCE SIGNS LIST

1 WINDOW REGULATOR
3 WIRE
4 TRAVELING BODY
5 MOTOR
6 HOUSING
9 DOOR
20 GUIDE RAIL
21 FIRST WIRE SUPPORT MEMBER
22 SECOND WIRE SUPPORT MEMBER
40 DRUM
71, 72 JOINING MEMBER
90 WINDOWPANE
91 OUTER WALL
92 INNER WALL

What is claimed is:

1. A window regulator provided in a door of a vehicle to raise and lower a windowpane in the door, the window regulator comprising:
a guide rail arranged along a travel direction of the windowpane;
a wire tensely fitted along a longitudinal direction of the guide rail; and
a traveling body that is guided by the guide rail and travels together with the windowpane,
wherein the traveling body comprises a drum with a part of the wire wound thereon, a motor that generates a drive force to rotate and drive the drum, and a housing that holds the drum and the motor, and
wherein both end portions of the wire are held by a pair of wire holding portions that are provided at an upper end portion and a lower end portion of the guide rail.

2. The window regulator according to claim 1, wherein the wire is tensioned by an elastic body held by the wire holding portions.

3. The window regulator according to claim 1, wherein the wire holding portion comprises a hole for housing a fixing member for fixing the guide rail to the door.

4. The window regulator according to claim 1, wherein a stopper comprising an elastic member for restricting the traveling body from moving downward is provided on one of the pair of wire holding portions that is arranged at the lower end portion of the guide rail.

5. The window regulator according to claim 2, wherein the wire holding portion comprises a hole for housing a fixing member for fixing the guide rail to the door.

6. The window regulator according to claim 2, wherein a stopper comprising an elastic member for restricting the traveling body from moving downward is provided on one of the pair of wire holding portions that is arranged at the lower end portion of the guide rail.

7. The window regulator according to claim 3, wherein a stopper comprising an elastic member for restricting the traveling body from moving downward is provided on one of the pair of wire holding portions that is arranged at the lower end portion of the guide rail.
